(19) United States
(12) Patent Application Publication
(10) Pub. No.: US 2004/0101617 A1
(43) Pub. Date: May 27, 2004

(54) Direct synthesis and deposition of luminescent films

(76) Inventors: P Sujatha Devi, Stony Brook, NY (US); Richard Gambino, Stony Brook, NY (US); Clare P Grey, Stony Brook, NY (US); Herbert Herman, Port Jefferson, NY (US); Hoshua Margolies, Port Jefferson Station, NY (US); John B Parise, Poquott, NY (US); Sanjay Sampath, Setauket, NY (US)

Correspondence Address: Leopold Presser, Scully Scott Murphy & Presser, 400 Garden City Plaza, Garden City, NY, 11530, US

(21) Appl. No.: 10/432,703

(22) PCT Filed: Nov. 27, 2001
(86) PCT No.: PCT/US01/44373

(51) Int. Cl. B05D 5/06; H05H 1/24

(52) U.S. Cl. 427/66; 427/68; 427/446; 427/569

(57) ABSTRACT

A method of forming luninescent films or coatings from a liquid precursor mixture utilizing a RF-induced plasma spraying process is disclosed. The inventive method results in the formation of luminescent films that have spherical, nano to micron sized particles associated therewith.

The present invention relates to luminescent films, and more particularly to a method of depositing luminescent ceramic oxide films or coatings such as rare-earth activated oxide phosphors utilizing a plasma spraying deposition technique such as radio frequency (RF) induced plasma spray deposition or any direct current (DC) plasma spray deposition technique wherein liquid precursors which are molecularly mixed in the presence of an inert plasma flame are employed. The films of the present invention are particularly useful in fluorescent lighting, solid-state lasers and conformal displays.

### BACKGROUND OF THE INVENTION

Interest in the growth and development of rare-earth activated phosphor thin films and powders for advanced display applications such as plasma, field emission displays (FEDs), electroluminescent and cathode ray tubes has increased significantly during the last decade. Thin films of photoluminescent and cathode luminescent materials have extensive application in flat panel displays such as field emission, plasma panel, electroluminescent and cathode ray tube. Thin films offer several advantages over traditional discrete powder films; for example, reduced light scattering, less material waste and the possibility of fabricating smaller pixel sizes that could provide high resolution for the color display. Additionally, thin films offer higher contrast, a high-degree of uniformity and crystallinity as well as better adhesion properties.

Rare-earth activated phosphors are attractive host materials for the development of advanced phosphors for FEDs due to their stability and environmental safety. Eu-activated Y₂O₃ is one of the most promising oxide-based red phosphors known so far. Due to a ⁵D₀-⁷F₂ transition within Eu, E—Y₂O₃ shows strong luminescent properties and emits red light around 611 nm. Thin films of Eu—Y₂O₃ have been developed by metallorganic chemical vapor deposition (CVD), spray pyrolysis, laser ablation, sputtering and sol-gel processes.

Thermal spraying is a widely acceptable technique for the production of thick ceramic coatings for industrial applications. In general, traditional plasma processes utilize powder feed-stocks of premixed compositions to develop fine grained deposits of ceramics, metals, or alloys. Prior art plasma spraying techniques which are based on powder precursors require unwanted handling and selection of powders. Additionally, prior art plasma spraying techniques based on powder precursors oftentimes result in the production of non-homogeneously mixed coatings or powders especially in multicomponent systems.

Attempts have been made to overcome the above-mentioned problems with powder precursors by replacing the powder precursors with liquid precursors. In such processes, the liquid precursor is typically atomized and then injected into a plasma torch where the atomized liquid is vaporized prior to deposition. U.S. Pat. No. 5,032,568 to Lau, et al. disclose such a prior art process. Specifically, Lau, et al. disclose a process for fabricating superconducting ceramic oxide films which includes the steps of: dissolving a metal salt in water; atomizing the aqueous metal salt solution; injecting the atomized solution into an inductively coupled RF plasma torch so as to vaporize the atomized solution; and thereafter depositing the vaporized solution onto a substrate so as to form a mixed oxide of the dissolved metal ions. After depositing the superconducting oxide film onto a substrate, the film is annealed in oxygen to introduce the correct oxygen stoichiometry into the deposited film. This oxygen annealing step may be eliminated if sufficient oxygen is present in the plasma, i.e., if an O₂ plasma is used.

U.S. Pat. No. 5,609,921 to Gitzhofer, et al. disclose a plasma spray method for agglomerating solid particles of a given material into at least partially melted drops using a particulate suspension in a liquid or semi-liquid material as a means to inject material into an RF induction plasma torch. Specifically, the method disclosed in Gitzhofer, et al. includes the steps of: producing an inductively coupled RF plasma discharge; providing a suspension of the material dispersed into a liquid or semi-liquid carrier substance; and atomizing the suspension into a stream of droplets; and, by means of the plasma discharge, (i) vaporizing the carrier substance and (ii) agglomerating the particles into at least partially melted drops. It is noted that in the process disclosed by Gitzhofer, et al. the phase formation may be partially completed prior to introduction into the plasma.

U.S. Pat. No. 6,013,318 to Hunt, et al. disclose a method for applying a coating to a substrate using a combustion chemical vapor deposition (CCVD) process. Specifically, the CCVD process disclosed in Hunt, et al. includes the steps of mixing together a reagent and a carrier solution to form a reagent mixture; igniting the reagent mixture to create a flame, or flowing the reagent mixture through a plasma torch in which the reagent is at least partially vaporized into a vapor phase; and contacting the vapor phase of the reagent to a substrate resulting in the deposition, at least in part from the vapor phase, of a coating of the reagent.

Although the above-mentioned prior art avoids the problems associated with powder precursors, these prior art methods require the use of separate oxygen annealing steps, O₂ plasmas, combustible reagents and/or suspensions which include solids that are carried in a liquid medium. Moreover, in the prior art processes, the liquid precursors are typically reacted together prior to entering the plasma reactor chamber. That is, the liquid precursors disclosed in the prior art are reacted together externally to the plasma spray flame and are then transferred to the plasma spray flame for vaporization. In such instances, the phase and the stoichiometry of the film deposited may be altered such that an unstable ceramic oxide film is formed.

Suspension plasma spray techniques, such as described in Gitzhofer, et al., do not allow for sufficient mixing of the reagents and they do not complete the decomposition reaction of the precursor within the plasma. CCVD techniques, such as described in Hunt, et al., create an accelerated CVD process aided by a combustible reagent and subsequent vapor phase deposition which results in the formation of films that do not contain fine particles. in view of the drawbacks mentioned hereinabove in regard to the production of luminescent ceramic oxides utilizing prior art plasma spraying techniques, there is a continued need for developing a new and improved plasma spraying process in which powder precursors, post oxygen annealing, 02 plasmas, combustible reagents and/or suspensions of a solid material carried in a liquid medium are not utilized. Such a technique would avoid the handling and selection of powders, resulting in the production of homogeneously mixed coatings or powders from a molecular mixed precursor.

### SUMMARY OF THE INVENTION

One object of the present invention is to provide a method for the direct synthesis and deposition of luminescent ceramic oxide films, wherein no powder precursors, post oxygen annealing, O₂ plasmas, combustible reagents and/or suspensions of a solid material carried in a liquid medium are utilized.

Another object of the present invention is to provide a method of forming a luminescent ceramic oxide film by utilizing an in-situ plasma spraying deposition technique, referred to as precursor plasma spraying (PPS), wherein molecularly mixed liquid feed-stocks, i.e., liquid precursors, are employed. Liquid precursors are preferred over other forms of precursors, i.e., powders or suspensions, since liquid precursors allow for the finest scale of mixing. The term “molecularly mixed precursor” is employed herein to denote liquid reactants that are reacted in the presence of an inert plasma spray flame.

A further object of the present invention is to provide a method of forming a luminescent ceramic oxide film which includes environmentally friendly and relatively inexpensive reactants and processing steps.

These and other objects and advantages are obtained in the present invention by utilizing a plasma spraying technique such as radio frequency (RF) induced plasma spray deposition or any direct current (DC) plasma spray deposition technique wherein molecularly mixed liquid-feed stocks, i.e., liquid precursors, are employed. Specifically, in one aspect of the present invention, a method for the direct synthesis and deposition of luminescent ceramic films or coating is provided. The method of the present invention comprises the steps of.

(a) providing a liquid precursor mixture which is capable of forming a luminescent ceramic oxide film and allowing said liquid precursor mixture to react in the presence of an inert plasma spray flame to produce a dehydrated, decomposed and reacted material; and

(b) depositing said dehydrated, decomposed and reacted material on a surface of a substrate utilizing a plasma spraying process.

In a highly preferred embodiment of the present invention, the inventive method further comprises a step of treating the deposited material with an inert plasma immediately following the deposition process. This plasma treatment step allows the active molecules in the deposited material to transform to a phase and stoichiometry which is capable of forming a stable ceramic oxide film.

In accordance with the inventive method, the liquid precursor mixture is a solution sol or solution having a pH of from about 3 to about 5 which comprises at least one refractory metal nitrate, refractory metal acetate, other like soluble refractory metal compound or complex and mixtures thereof In some embodiments wherein YAG-type films are formed, the liquid precursor mixture also includes at least one oxygen-containing compound. In other embodiments of the present invention, the liquid precursor (i.e., soluble refractory metal compound or complex; or mixture of soluble refractory metal compound or complex and oxygen-containing compound) may include, as a doping species, a lanthanide element such as La, Ce, Pr, Nd, Pm, Sm, Eu, Gd, Th, Dy, Ho, Er, Tm, Yb or Lu, or a Group IVB metal such as Cr, Mo, or W.

The inventive method forms luminescent ceramic films including, but not limited to: yttrium aluminum garnet (Y₃Al₅O₁₂, i.e., YAG), Eu-doped Y₂O₃, Cr-doped YAG Eu-doped YAG and Cr-doped Al₂O₃. The luminescent ceramic films of the present invention are homogeneous coatings which are formed from a molecularly mixed precursor. Moreover, the inventive method results in the production of luminescent films having spherical, nano to micron sized polycrystalline or crystalline deposits associated therewith. The deposits of the present invention are composed of randomly oriented grains.

In one embodiment of the present invention, a patterned mask is present atop a surface of the substrate prior to depositing the liquid precursor mixture on the substrate. In this embodiment of the present invention, the patterned mask, which is formed by deposition, and lithography, includes at least one opening which exposes a portion of the substrate. During this embodiment of the present invention, the luminescent ceramic oxide film is formed only on the exposed portions of the substrate provided by the at least one opening so as to form, after removing the patterned mask, a substrate which includes a patterned luminescent ceramic oxide film thereon. In another embodiment of the present invention, the patterned mask is a hardmask which includes one or more openings providing thereon.

A dynamic aperture approach may also be employed in the present invention to form ceramic oxide films that are patterned.

### BRIEF DESCRIPTION OF THE DRAWINGS

FIGS. 1(a)-(c) are X-ray diffractograms of precursor plasma-sprayed yttrium aluminum garnet coatings; (a) as-sprayed, (b) treated with plasma for 10 seconds, and (c) as-sprayed powder calcined at 1250° C./6 hours.

FIGS. 2(a)-(c) are XRD patterns of YAG sol calcined at different temperatures; (a) as-dried sol, (b) 1000° C./1 hour, and (c) 1350° C./6 hours.

FIGS. 3(a) and (b) are SEM pictures of YAG coatings; (a) as-sprayed, and (b) treated with plasma for 10 seconds.

FIGS. 4(a) and (b) are ²⁷Al MAS NMR spectrum; (a) YAG sol, and (b) plasma treated YAG coating.

FIGS. 5(a) and (b) are XRD patterns of Eu-doped Y₂O₃ on various substrates; (a) Si (100), and (b) steel.

FIGS. 6(a) and (b) are photoluminescence images of Eu-doped Y₂O₃ on various substrates; (a) Si (100), and (b) steel.

### DETAILED DESCRIPTION OF THE INVENTION

As stated above, the present invention provides a method for fabricating a luminescent ceramic oxide film by spraying a molecularly mixed liquid precursor mixture onto a surface of a substrate utilizing a plasma deposition technique. It is noted that the inventive process is carried out in the absence of powder precursors, and that the inventive process does not include the use of any combustible reagents, post oxygen anneals, O₂ plasmas or a suspension (i.e., solids carried in a liquid medium) as a means to inject the precursor material into the plasma torch.

Specifically, the method of the present invention comprises the steps of providing a liquid precursor mixture which is capable of forming a luminescent ceramic oxide film and allowing said liquid precursor mixture to react directly inside (i.e., in-situ) a plasma chamber to form a dehydrated, decomposed and reacted material; and depositing said dehydrated, decomposed and reacted material on a surface of a substrate utilizing a plasma spraying process. It is noted that the reaction occurs in the presence of the thermal spray flame, not external to the flame as is the case in some prior art plasma deposition processes. Hence, in the inventive method, the reaction of liquid precursors occurs inside the plasma spray itself thereby forming a decomposed and well reacted oxide phase.

The term “plasma spray deposition process” is used herein to denote any deposition process wherein reactants can be formed into droplets via a plasma flame. Examples of plasma spray deposition processes that can be utilized in the present invention include, but are not limited to: radio frequency (RF) induced plasma spray deposition or any direct current (DC) plasma spray deposition technique. Of the various plasma spray deposition processes, it is highly preferred to employ RF induced plasma spray deposition in the present invention. It is noted that the inert plasma flame employed in the present invention is a non-oxygenated plasma such as Ar or Ar/He where He is employed as the carrier gas.

The liquid precursor mixture employed in the present invention includes any solution sol or solution which is capable of forming a ceramic oxide film on a surface of a substrate upon utilizing the inventive spraying process. The liquid precursor employed in the present invention should have a pH of from about 3 to about 5. This pH range is important in the present invention since it ensures metal stoichiometry at an atomic level during atomization so as to avoid phase separation or precipitation and/or to main a stable precursor. It is noted that if the pH is outside the range specified above, the pH of the liquid precursor may be adjusted by adding either conventional acids such as nitric acid or bases such as ammonium hydroxide to the liquid precursor. Specifically, the solution sol or solution employed in the present invention comprises at least one refractory metal nitrate,. refractory metal acetate, other like soluble refractory metal-containing compound or complex (i.e., polymeric citrate-nitrate complex) and mixtures thereof which is capable of forming a luminescent ceramic oxide film. In some embodiments of the present invention such as in the formation of a YAG film, the liquid precursor may also include at least one oxygen-containing compound.

The liquid precursor may also include, as a doping species, a lanthanide element, i.e., rare-earth element, such as La, Ce, Pr, Nd, Pm, Sm, Eu, Gd, Th, Dy, Ho, Er, Tm, Yb or Lu, or a Group IVB metal such as Cr, Mo, or W. Mixtures of these doping species are also contemplated in the present invention. Of the various listed doping species, it is preferred to use Eu or Cr in the present invention. When a doping species is to employed, the dopant species is added to the sol solution or solution as a soluble liquid material in amounts which are capable of forming a ceramic oxide film. Color specific doping species such as Eu for red emission, Tb for green emission and Ce for yellow emission can be used to produce a film that emits one or more colors. In a preferred embodiment of the present invention, all three doping species can be simultaneously added to a liquid precursor and deposited and subsequently selectively excited (i.e., activated by an appropriate light length or voltage) for illumination in the entire film or a specific pixel in the film.

It is noted that the present invention contemplates liquid precursors that include at least one refractory metal compound or complex; a mixture of at least one refractory metal compound or complex and at least one doping species; a mixture of at least one refractory metal compound or complex and at least one oxygen-containing compound; and a mixture of at least one refractory metal compound or complex, at least one oxygen-containing compound and at least one doping species.

The term “refractory metal” as used herein denotes a metal that has a low thermal conductivity that is capable of withstanding extremely high temperatures (on the order of 1500° C. or above). Suitable refractory metals that may be employed in the present invention include, but are not limited to: Y, Mo and W. Of these refractory metals, it is highly preferred to use Y (yttrium) as the refractory metal. Of the Y compounds, Y nitrates such as yttrium nitrate hexahydrate are highly preferred. Y acetates and other soluble Y salts are also contemplated herein.

In cases wherein the liquid precursor mixture also includes at least one 10 oxygen-containing compound, an oxygen-containing compound such as boehmite, AlO.OH which is capable of reacting with the refractory metal-containing compound to form a ceramic material can be employed in the present invention. In addition to Al-containing oxygen compounds, the present invention also contemplates Ti-containing oxygen compounds and silicon-containing oxygen compounds.

The ratio of oxygen-containing compound to refractory metal compound employed in the present invention may vary depending upon the desired final ceramic oxide film to be formed.

The solution sol or solution employed in the present invention is formed utilizing conventional processes that are well known to those skilled in the art. For example, when a solution sol containing a mixture of at least one refractory metal compound or complex and at least one oxygen-containing compound is to be employed, the liquid precursor is prepared by dispersing the required amount of oxygen-containing compound in a solvent such as water by continuous stirring, followed by the addition of the appropriate amount of an aqueous solution of at least one refractory metal compound (i.e., nitrate or acetate). If needed, the pH of the solution may be adjusted so as to obtain a pH value within the range of 3-4. Various acids such as nitric acid may be employed for adjusting the pH of the solution; The precursor mixture thus formed is stirred for an additional time period until a stable opaque mixture forms.

The liquid precursor described above, is then allowed to react in the presence of an inert plasma flame to produce a dehydrated, decomposed and reacted mixture which is then sprayed on to a suitable substrate utilizing a conventional plasma torch apparatus. The substrate may be optionally cleaned prior to spraying utilizing a conventional cleaning process well known to those skilled in the art. Suitable substrates that may be employed in the present invention include, but are not limited to: semiconductor substrates such as Si wafers, metallic substrates, stainless steel, polymeric substrates and other like substrates in which a stable luminescent ceramic film can be formed.

The operational conditions for the plasma spraying process employed in the present invention may vary depending upon the desired ceramic oxide film to be formed. Table 1 of Example 1 provides exemplary operational conditions that can be employed in the present invention. These given operational conditions for the plasma spraying. step employed in the present invention by no way limit the invention. Other operational conditions which are capable of spraying the liquid precursor mixture of the present invention onto a substrate can be employed herein. In accordance with the present invention, the ceramic oxide film is formed by atomized droplets of the liquid precursor instead of melting as in conventional plasma deposition processes.

Without wishing to be bound by any theory, it is believed that the mechanisms of precursor deposition of the present invention are as follows:

(i) The liquid precursor mixture is first atomized into spherical droplets which enter the thermal plasma zone.

(ii) Dehydration, decomposition reaction and formation of an oxide material takes place within the droplet in the plasma yielding fine spherical homogeneously particles or clusters. Formation of the correct phase for the film most likely occurs in the decomposed droplet itself.

(iii) The resulting particles or clusters of particles (either as a solid or in some cases partially melted) impinge on the substrate and form a homogeneous deposit; This homogeneity has been verified with micro-diffraction techniques assign spatial variations in phase distribution.

Although some vapor phase deposition may take place directly, the inventive process predominately takes place in the steps outlined above. This is corroborated by the fact that the deposit contains a significant portion of fine rounded particles and randomly oriented grains. Vapor phase deposits would yield more pronounced epitaxial films with no fine particles (e.g., as in conventional CVD). Furthermore, the deposits of the present invention are very homogeneous in terms of phase content, which is likely the result of direct conversion of precursor to oxide in the plasma itself within the droplet and not within the vapor phase consolidation in the substrate. The rate of deposit formation is very rapid (10's of microns within a few seconds) which is unlikely in an atom-by-atom type building process such as is the case in vapor phase deposition.

As indicated in Table 1, the plasma spray deposition process may include a preheating step and a post-heat treatment step which are performed in present of an inert atmosphere. These preheating and post heating steps are optional and need not be employed in the present invention if proper precursor chemistry is chosen. The plasma spray deposition processing step of the present invention is conducted in the presence of an inert gas such as He, Ar or a mixture thereof. The spraying step may be conducted one time or it may be repeated any number of times to form a thick luminescent film. Alternatively, a stack of luminescent ceramic oxide films having the same or different chemical composition may be formed by repeating the processing steps of the present invention.

In a highly preferred embodiment of the present invention, the deposited material is treated with an inert plasma immediately following the deposition step. This plasma treatment processing step allows active molecules in the deposited material to transform to a phase and stoichiometry which is capable of forming a stable ceramic oxide film. Specifically, the plasma treatment step is performed at a temperature of about 500° C. or higher for a time of about 30 seconds or less. More preferably, the plasma treatment step is performed at a temperature of from about 700° to about 1000° C. for a time of about 15 seconds or less.

It is noted that the inventive process results in the production of a ceramic oxide film which has spherical, nano to micron sized polycrystalline particles present therein. Highly crystalline films can be obtained with or without a doping element.

In addition to be useful for fabricating luminescent ceramic films which may find applications in fluorescent lighting or solid-state lasers, the inventive method may also be useful in forming magnetic films or photocatalytic films. In the case of magnetic films, the inventive method provides nano particles having improved electronic, optical and magnetic properties. Super paramagnetic properties are unique features of magnetic nano particles. Their potential applications include ferrofluid technology and magneto-caloric refrigerations. Super paramagnetic nano particles are also employed in biomedicine and technology such as contrast agents in MRI (magnetic resonance imaging). Yttrium iron garnet is one of the most suitable soft magnetic materials with extensive use in microwave applications. Moreover, yttrium iron garnet also finds applications in magneto-optical recording application where controlled particle size is a crucial factor to reduce light absorption and scattering.

In the case of photocatalytic films, doped deposits of TiO₂ photocatalysts could find applications in the removal of organic and inorganic contaminants from aqueous waste streams. Application of the inventive method to the walls of water storage tanks may enable removal, detoxification and recovery of heavy metals along with the destruction of organics in combined waste streams.

In an optional embodiment of the present invention, a conventional masking material such as a photoresist is applied to the surface of the substrate prior to deposition of the luminescent ceramic oxide film. The masking material is applied using a conventional deposition process well known in the art including, but not limited to: chemical vapor deposition (CVD), plasma-assisted CVD, sputtering, chemical solution deposition or spin-on coating. Following application of the masking material to the substrate, the masking material is subjected to conventional lithography which includes the steps of: exposing the masking material to a pattern of radiation and developing the pattern into the masking material utilizing a conventional developer solution. The development step results in the formation of a patterned mask which includes at least one opening that exposes a portion of the substrate. With the patterned masking layer in place, the inventive process is carried out such that the luminescent ceramic metal oxide film is formed atop the exposed portions of the substrate provided by the at least one opening in the patterned mask. Following the inventive deposition process, the patterned mask is removed from the surface of the substrate utilizing a conventional stripping process well known in the art so as to form a structure which includes a patterned luminescent ceramic metal oxide film present thereon.

In another embodiment of the present invention, a hardmask having one or more openings formed therein is formed atop the surface of the substrate prior to conducting the processing steps of the present invention. This embodiment of the present invention also results in the formation of a patterned luminescent ceramic oxide on the surface of the substrate.

In still another embodiment of the present invention, a dynamic aperture technique can be employed to form a patterned luminescent ceramic oxide film on a surface of a substrate. The dynamic aperture technique utilizes two translatable shims with a gap that are continuously rolled to produce a dynamic masking system. The gap width between the shims can be adjusted to produce precise patterns and can be dynamically varied. The aperture system does not have to be in contact with the substrate thereby enabling deposition on complex geometries. This procedure, which has been developed and applied to powder based thermal spray technology, is described in greater detail in co-pending and co-assigned U.S. Pat. application Ser. No. 09/863,482, filed on May 23, 2001, the entire contents of which are incorporated herein by reference. The approach mentioned in the aforementioned U.S. Patent Application in combination with the inventive method described hereinabove allows for fabricating patterned films that have the ability to change composition (by changing the precursor chemistry) and structure (by changing the process conditions) laterally (within the X-Y plane) as well as through thickness.

The following examples are given to illustrate some of the advantages that can be obtained from the present invention.

### EXAMPLE 1

In this example, a yttrium aluminum garnet (Y₃Al₅O₁₂, YAG) film was prepared in accordance to the method of the present invention. Specifically, a YAG precursor sol was first prepared by dispersing the required amount of boehmite powder (Catapal D. Vista Chemical Co., Houston Tex.) in H₂O by continuous stirring, followed by the addition of an aqueous solution of yttrium nitrate hexahydrate, Y(NO₃)₃.6H₂O (Aldrich 99.9%). The pH of the resultant slurry was adjusted to about 3-4with nitric acid and the suspension was stirred for about 2-3 hours until it became a stable opaque sol. A hybrid sol such as this, where one component is added as a colloid and the other as a soluble metal salt, offers a number of advantages including high yield fast production rates and uniform phase distribution of the final product.

The YAG solution with an Y:Al ratio of 3:5 and a final concentration of 25 g/L was sprayed onto a substrate using a RF plasma torch (Tafa Model 66) apparatus under a series of spary conditions. Compared to direct current (DC) plasma, the RF plasma is an electrodeless technique which offers the advantage of a clean operation procedure. The optimized spray conditions for obtaining YAG coatings are present in Table 1 below. Steel plates having an area of 6×6×0.2 cm³ or larger were used as substrates and the substrate holder was moved horizontally during the spraying operation. The average residence time of the particles in the plasma was around 1 second and the average time required per plate for developing a coating of about 60 to about 100 μm was approximately 60 seconds.

TABLE 1
Conditions of Precursor Plasma Spraying of YAG

| CONDITIONS | PARAMETERS |
|---|---|
| Power | 65 Kw |
| Chamber Pressure | 100-250 torr |
| Plasma Swirl Gas | Ar (25 slpm) |
| Plasma Radial Gas | Ar/He (70/140 slpm) |
| Atomizing Gas | He |
| Feed Sock Material | 5.5 wt. % YAG sol |
| Feed Rate | 10-30 ml/mm |
| Substrate-Torch Distance | 100-150 mm |
| Traverse Speed | 2.5 cm/s |
| No. of Cycles | 0.2/5-8/0-5 (Preheat/Deposit/Post-heat) |

The spray coating, the dried precursor sol and the calcined powders were characterized by powder X-ray diffraction, XRD, (SCINTAG/PAD-V diffractometer) at a scan rate of 1° C./min using CuKα radiation. Morphological analyses and energy dispersive X-ray analysis (EDX) were performed on a (Jeol/JSM-840A) scanning electron microscope. ²⁷Al MAS (Magic Angle Spinning) NMR experiments were performed with a double-tuned Chemagnetics 5 mm probe (CMX-360 spectrometer) at an operating frequency of 93.8 MHz. ²⁷Al chemical shifts are externally quoted relative to a saturated aqueous Al₂(SO₄)₃ solution at 0 ppm.

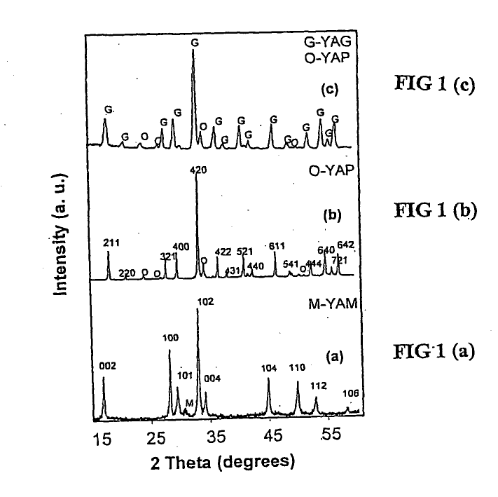

The XRD powder pattern of an as-sprayed coating from a sol of metal stoichiometry Y:Al 3:5 is shown in FIG. 1 (a). All the observed reflections are identical to the reported H-YalO₃(JCPDS#16-219), except for a single reflection corresponding to the YAM phase. The absence of any Y₂O₃ or Al2O₃ reflections in the as-sprayed coating further indicates the absence of phase separation in the starting precursor. This also rules out any selective decomposition of Y(NO₃)₃ or AlO.(OH) during the atomization and spray process. Since the starting stoichiometric ratio of Y:Al was 3:5 in the precursor, amorphous Al₂O₃ is thought to be present in the coating to compensate for the Al deficiency.

The as-sprayed layers were further treated with the plasma for about 10 seconds, which resulted in a dramatic change in phase development and a substantial growth in crystallite size, as evident from the sharp X-ray reflections in FIG. 1(b). Almost all the reflections could be indexed based on the cubic garnet phase (JCPDS # 33-40). The reflections marked ‘O’ in the X-ray pattern correspond to the O-YAP (JCPDS # 33-41) phase. Immediate crystallization of YAG after the post treatment confirmed that H-YAP is a transient metastable intermediate state which could be converted to YAG very easily. Furthermore, the formation of a small amount of O-YAP suggested a possible conversion of the monoclinic YAM phase to the orthorhombic YAP phase. The absence of any reflections from the substrate material indicated a continuous thick deposit of YAG.

In order to gain more insight into the conversion from H-YAP to YAG during the post treatment with plasma (Ar/He), the powders collected before treatment were calcined and studied by XRD. A systematic growth of the YAG phase and a disappearance of the H-YAP were observed during calcinations. It is noted that a calcinating temperature of about 1250° C. for about 6 hours was necessary to induce a phase change, See FIG. 1(c), identical to the post-treated plasma deposit shown in FIG. 1(b), wherein a maximum surface temperature of about 900° C. only was noted during spraying.

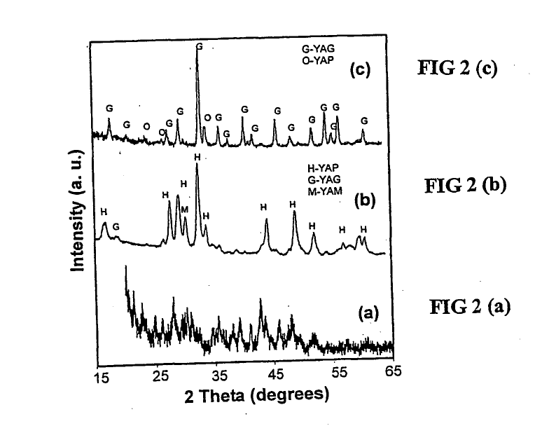

It is note worthy to compare the phase changes during the calcinations of the dried sol at different temperatures, See FIGS. 2(a-c). The diffraction pattern of the as-dried sol indicates partial crystallinity and the weak reflections correspond to AlO.(OH) and Y(NO₃)₃, with no indication of either Y₂O₃ or Al₂O₃. XRD patterns of the as-sprayed coating, i.e., FIG. 1(a), and that of the sol calcined at 1000° C. for 1 hour, See FIG. 2(b), on the other hand, suggest the formation of the Y-rich phases, H-YAP and YAM. Their presence in the coatings indicates micro scale chemical reactions within the atomized droplet, similar to the one occurring during calcinations of the sol, prior to deposition. It suggests that the Y³⁺ions get entrapped in the boehmite sol particles, resulting in in-situ micro-scale reactions within individual droplets and thereby controlling the chemistry of phase formation during spraying. Further calcinations of the dried sol showed a systematic growth in the garnet phase and the one calcined at 1350° C. for 6 hours (FIG. 2(c)) is almost identical to the post-treated plasma deposit (FIG. 1(b)).

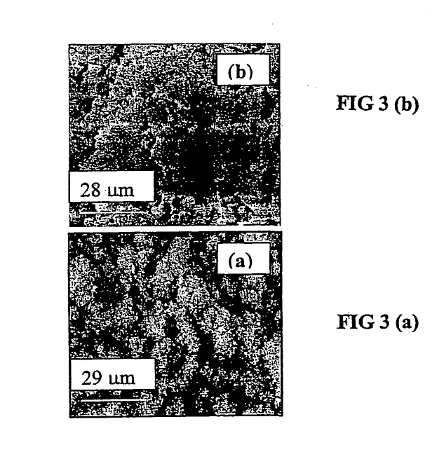

The SEM micrographs of the as-sprayed and post-treated coatings are shown in FIG. 3(a) and 3(b). It is very clear from the image of the as-sprayed coating that the particles remain spherical in shape with very small size, See FIG. 3(a), indicating that no melting has occurred during. spraying. There is substantial grain growth after post treatment with the plasma, resulting in a reasonably dense and coherent deposit, See FIG. 3(b). The average metal ratios were determined on the post treated specimen by EDX and the metal stoichiometry corresponded to Y:Al=3.0:5.3, which is close to the Y₃Al₅O₁₂ composition. However, when the spot analysis mode was employed a few grains with the Y:Al ratio corresponding to 1:1 were obtained confirming the presence of YAlO₃.

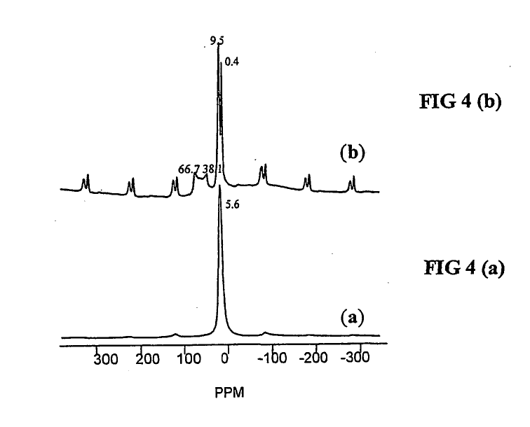

In the garnet lattice, aluminum ions occupy both tetrahedral and octahedral coordination sites in the ratio 3:2. ²⁷Al MAS NMR was utilized for further confirmation of the garnet phase formation and different coordination stats of Al centers in these sprayed materials. The ²⁷Al NMR sol, see FIG. 4(a), showed a single resonance (5.6 ppm) in the region characteristic of octahedrally coordinated Al, similar to the one present in the boehmite sol. On the other hand, the spectrum of the garnet coating showed an intense narrow resonance at 0.4 ppm, with spinning side bands assigned to Al in the octahedral site and a typical line shape for Al in a distorted tetrahedral environment spreading from 70 to 30 ppm (see, FIG. 4(b)) as reported earlier in the article to D. Massiot, et al. “A Quantitative Study of ²⁷Al MAS NMR in Crystalline YAG”, J. Magn., Res., 90 231-242 (1990). In addition, there is another strong sharp signal at 9.5 ppm, which is assigned to an octahedrally coordinated Al site, different from that of garnet. The X-ray pattern (FIG. 1(b)) of the same material confirms the presence of orthorhombic YAP phase, in addition to YAG which contains Al in an octahedrally coordinated environment. This phase was previously reported in the D. Massiot, et al. article to give a single resonance at 9.4 ppm in ²⁷Al MAS NMR. Therefore, the resonance at 9.5 ppm from the garnet coating is assigned unequivocally to that of octahedral Al site in orthorhombic YAlO_{3.}

The formation of the garnet phase in the plasma post-treated coating (FIG. 1(b)) as well as in the annealed sol (FIG. 2(c)) and the as-sprayed powder (FIG. 1(c)) indicated compositional homogeneity in the starting sol. The precursor is obviously not homogeneous at an atomic level however, as evidenced by the presence of a minor amount of O-YAP in the above materials. The crystallization of H-YAP during spraying suggests that metastable phases may be formed, presumably due to the fast heating rates and short residence times. Nevertheless, by carefully controlling the spray conditions it is possible to produce garnet deposits of reasonable thickness (60-100 μm), crystallinity (30-50 nm) and uniformity. Most interestingly, the overall process of spraying, phase formation and deposition occurs in a very short time of around forty seconds, whereas obtaining the same phase in the powder form rather than coating requires isothermal heating for 25560 s.

Unlike normal plasma spraying, where the feed stock material melts and forms a coating upon impact with the substrate, the precursor route employed in the present invention involves controlling the chemistry of phase formation during the spray process. Hence, the inventive method could open up new avenues in developing complex functional oxide deposits, where control of chemistry is a crucial factor. In addition, since the plasma provides elevated temperatures, new materials could be deposited directly from liquid precursors. The inventive method can also produce both stable and metastable phases, depending on the process parameters, as demonstrated by the phase stabilization of YAG and H-YAP. Thus the inventive method offers a wide spectrum of opportunities in material synthesis and deposition, that would not be feasible through other existing plasma techniques.

In conclusion, nano structured deposits of yttrium aluminum garnet (Y₃Al₅O₁₂) were prepared for the first time by precursor plasma spraying through a radio frequency plasma technique. This is achieved by the injection of atomized liquid droplets of the YAG precursor sol into the plasma plume, resulting in the formation of adherent and chemically controlled garnet deposits. The overall process of spraying, atomization and chemical reaction occurred within a very short time (40 s), indicating the simplicity of the inventive method. The inventive method could further be extended to develop large area thick/thin coatings of YAG in a single step on many substrates and hence could find applications in developing insulating ceramic coatings or optical wave-guides.

### EXAMPLE 2

In this example, a series of Eu or Cr doped Y₂O₃ or YAG films were prepared in accordance with the inventive method. For the production of the films different types of precursors were used such as a solution (nitrates, acetates etc) sol or a polymeric citrate-nitrate complex precursor.

(1). The YAG precursor sol was prepared by dispersing the required amount of boebmite powder (Catapal D. Vista Chemical Co., Houston, Texas) in H₂O by continuous stirring, followed by the addition of an aqueous solution of yttrium nitrate hexahydrate, Y(NO₃)₃.6H₂O (Aldrich, 99.9%). The pH of the slurry was adjusted to about 3-4 with nitric acid and the suspension was stirred for about 2-3 hours until it became a stable opaque sol. Boehmite sol could also be made starting from aluminum nitrate solution. A hybrid sol such as this, where one component is added as a colloid and the other as a soluble metal salt, offers a number of advantages including high yield, fast production rates and uniform phase distribution of the final product.

(2). The doped YAG precursor sol was prepared as above from the required amount of boelunite powder (Catapal D. Vista Chemical Co., Houston, Tex.) yttrium nitrate hexahydrate, Y(NO₃)₃.6H₂O (Aldrich, 99.9%) and europium nitrate penta hydrate Eu(NO₃)₃.5H₂O (Aldrich, 99.9%) or chromium acetate or nitrate.

The YAG sol with an Y:Al ratio of 3:5 and a final solid concentration of 25 g/L was sprayed using the RF plasma torch (Tafa Model 66) under a series of spray conditions. The optimized spray conditions for obtaining YAG coatings are presented in Table 1 above. Steel plates of area 6×6×0.2 cm³ or larger were used as substrates and the substrate holder was moved horizontally during spraying. The average residence time of the particles in the plasma was around l second and the average time required per plate for developing a coating of about 60 to 100 μm was around 40 seconds.

(3). The precursor solution for Eu—Y₂O₃ was prepared by dissolving yttrium nitrate hexahydrate, Y(NO₃)₃.6H₂O (Aldrich, 99.9%) and europium nitrate penta hydrate, Eu(NO₃)₃●5H₂O (Aldrich, 99.9%), in separate aliquots of distilled water. The stock solutions were mixed in such a way that the molar ratio of Y:Eu is 98:2. The pH of the mixture was adjusted to 4 with NH₄OH and the mixed solution was stirred for 2-3 hours to make it a homogeneous mixture. Here the ratio of Y:Eu could be varied very easily for optimum results. The precursor solution was sprayed using the RF plasma torch (Tafa Model 66) under a series of spray conditions. For the development of the coatings, the precursor sol was fed to the RF plasma torch and directly gas atomized into the plasma (Ar/He) through an atomizing probe. Steel plates and Silicon (100) substrates were used and the substrate holder was moved horizontally during spraying.

The sprayed coatings, the dried precursor sol and the calcined powders were characterized by powder x-ray diffraction, XRD (SCINTAG/PAD-V diffractometer ) at a scan rate of 2°/min using CuKα radiation. Morphological analyses and energy dispersive x-ray analysis (EDX) were performed on a (Jeol/JSM-840A) scanning electron microscope. Photoluminescence measurements were carried out on a Fluorolog 2 Spectrophotometer.

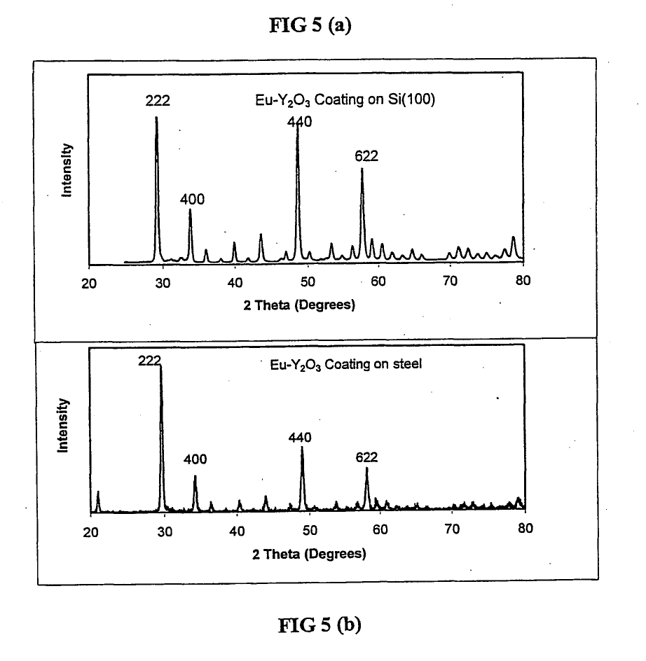

FIGS. 5(a) and 5(b) show the XRD patterns of Eu-doped Y₂O₃ films grown on a Si (100) and a steel substrate, respectively. The films grown on steel revealed the growth of polycrystalline cubic Y₂O₃ films with no preferred orientation and all the peaks could be indexed based on the JCPDS file # 41-105. Eu-doped Y₂O₃ films grown on Si(100) by the laser ablation or CVD normally produces thin films with preferred (111) or (100) orientation or produces a mixture of monoclinic and cubic Y₂O₃. In here, the absence of Si (100) substrate peak indicates that the deposits are really thick. It is interesting to note that the deposits on both surfaces produce cubic Y₂O₃ as the only crystalline phase.

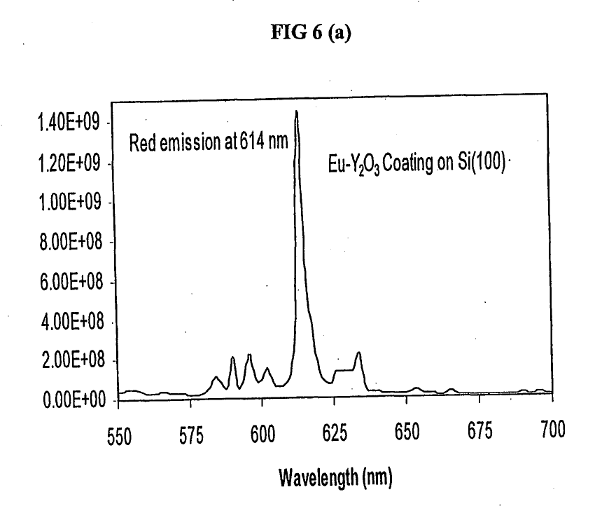

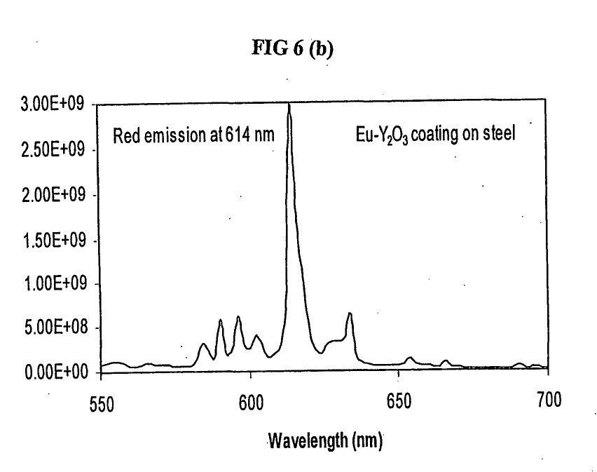

FIGS. 6(a)-6(b) show the photoluminescence image taken with a UV lamp (Mineralight) where strong luminescence from the red phosphor is evident. A typical photoluminescence spectrum of a Eu-doped Y₂O₃ film produced on Si(100) is shown in FIG. 6(a) and steel substrates are shown in FIG. 6(b). The films were excited with 259 nm excitation wavelength. The emission spectra is dominated by the red emission peak at 614 nm, which is the ⁵D₀→⁷F₂ transition of Eu³⁺. The narrow emission peaks (FWHM around 2-4 nm) indicates an improved local crystallinity and grain size of the phosphor particles. Further, the strong and narrow 614 nm feature is a very good indicator of cubic Y₂O₃. Interesting optical properties were obtained from YAG-Eu and YAG-Cr as well.

Above results confirm that it is possible to develop phosphor coatings of a variety of rare-earth (Tb, Ce, Nd, Tm) doped materials by this process, thus opening up avenues in developing large area flat panel displays directly from a solution precursor. The inventive method is also environmentally friendly, cheaper and faster to develop.

### COMPARATIVE EXAMPLE

In a comparative study, Ar/O₂ and Ar/air plasmas were used as the plasma gas in place of the Ar/He plasma mentioned in Examples 1 and 2. In some cases air was used as the carrier gas for the precursor. The other conditions and materials described in Examples 1 and 2, except for the type of plasma, were also used here for this comparative example. In the comparative example, the oxygenated plasmas did not yield a deposit on the substrate. The use of Ar/He plasmas and the use of He as a carrier gas enabled both deposition of the precursors as well as the synthesis of the correct phases. This is attributed to the superior heat transfer coefficient of the He component in the plasma which allows for rapid decomposition of the liquid precursor and formation of the solid oxide phase.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope and spirit of the appended claims.

Having thus described our invention in detail, what we claim is new and desire to secure by the letters patent is:

1. A method of forming a luminescent film on a surface of a substrate comprising the steps of:
(a) providing a liquid precursor mixture which is capable of forming a luminescent ceramic oxide film and allowing said liquid precursor mixture to react in the presence of an inert plasma spray flame to produce a dehydrated, decomposed and reacted material; and
(b) depositing said dehydrated, decomposed and reacted material on a surface of a substrate utilizing a plasma spraying process.

2. The method of claim 1 wherein said liquid precursor mixture includes at least one soluble refractory metal compound or complex.

3. The method of claim 2 wherein said at least one soluble refractory metal compound or complex is selected from the group consisting of a refractory metal nitrate, refractory metal acetate, refractory citrate-nitrate complex and mixtures thereof.

4. The method of claim 2 wherein said at least one soluble refractory metal compound or complex includes Y, Mo or W.

5. The method of claim 2 wherein said at least one soluble refractory metal compound includes Y nitrate, Y acetate or Y citrate-nitrate.

6. The method of claim 2 wherein said liquid precursor mixture further includes at least one oxygen-containing compound.

7. The method of claim 6 wherein said at least one oxygen-containing compound is selected from the group consisting of an Al-containing oxygen compound, a Ti-containing oxygen compound, a silicon-containing oxygen compound and mixtures thereof

8. The method of claim 6 wherein said at least one oxygen-containing compound is boebmite.

9. The method of claim 2 wherein said liquid precursor mixture further includes at least one doping species.

10. The method of claim 9 wherein said at least one doping species is a lanthanide element or a Group IVB metal.

11. The method of claim 8 wherein said at least one doping species is Eu or Cr.

12. The method of claim 1 wherein said liquid precursor mixture is selected from the group consisting of at least one refractory metal compound or complex; a mixture of at least one refractory metal compound or complex and at least one doping species; a mixture of at least one refractory metal compound or complex and at least one oxygen-containing compound; and a mixture of at least one refractory metal compound or complex, at least one oxygen-containing compound and at least one doping species.

13. The method of claim 12 wherein said doping species comprise a color specific doping species.

14. The method of claim 13 wherein said color specific doping species is Eu, Th, Ce or any combination thereof

15. The method of claim 1 wherein said inert plasma is an Ar/He plasma.

16. The method of claim 1 wherein said depositing step is carried out in the presence of an inert gas.

17. The method of claim 16 wherein said inert gas is He, Ar or a mixture thereof.

18. The method of claim 1 wherein said depositing step forms spherical, nano or micron sized particles on said substrate.

19. The method of claim 1 wherein said luminescent ceramic oxide film is formed by atomized droplets of said liquid precursor mixture.

20. The method of claim 1 wherein said luminescent ceramic oxide film is a polycrystalline film.

21. The method of claim 1 wherein said luminescent ceramic oxide film comprises randomly oriented crystals.

22. The method of claim 1 further comprising plasma treating the deposited liquid precursor to allow active molecules in said deposited liquid precursor mixture to convert to a phase and stoichiometry which is capable of forming a stable ceramic oxide film.

23. The method of claim 22 wherein said plasma treating is performed at a temperature of about 500° C. or higher for a time of about 30 seconds or less.

24. The method of claim 1 further comprising the step of providing a patterned mask having at least one opening that exposes a portion of said substrate prior to performing step (a).

25. The method of claim 24 wherein said patterned mask is formed by deposition and lithography.

26. The method of claim 24 wherein said patterned mask is comprises of a photoresist material.

27. The method of claim 24 wherein said patterned mask is a hardmask.

28. The method of claim 1 wherein steps (a)-(b) are repeating any number of times to form a multilayered film stack on said substrate.

29. The method of claim 1 wherein said plasma spraying process is a radio frequency (RF) induced plasma spray process or a direct current plasma spray process.

30. The method of claim 29 wherein said plasma spraying process is a radio frequency (RF) induced plasma spray process.

31. The method of claim 1 wherein said liquid precursor mixture has a pH of from about 3 to about 5.
